(19) United States
(12) Patent Application Publication
(10) Pub. No.: US 2026/0070482 A1
(43) Pub. Date: Mar. 12, 2026

(54) FIXED SLIDE OUT COVER FOR A RECREATIONAL VEHICLE

(71) Applicant: Kevin Donald Thelen, Westphalia, MI (US)

(72) Inventor: Kevin Donald Thelen, Westphalia, MI (US)

(21) Appl. No.: 18/827,716

(22) Filed: Sep. 7, 2024

(51) Int. Cl. B60P 3/34

(52) U.S. Cl. CPC B60P 3/343

(57) ABSTRACT

A fixed slide out cover may be secured to a recreational vehicle so that the fixed slide out cover spans a top area above a slide out element. The fixed slide out cover is formed to a fixed length based on the distance between the exterior wall of the recreational vehicle and a distal end of the slide out element. This enables the fixed slide out cover to be pulled tight over the top surface of the slide out element, and enables the fixed slide out cover to resist sagging or billowing that other types of slide out covers may be prone to, such as retractable slide out covers.

### BACKGROUND

Many types of recreational vehicles are equipped with at least one slide out element. A slide out element refers to a modular moveable section of a recreational vehicle that can be laterally moved between a stowed position and a deployed position. For example, by following a manufacture manual, a slide out element may be laterally slid to the stowed position for transportation of the recreational vehicle, and the slide out element may be laterally moved to the deployed position at a stationary destination (e.g., a dealership, a campsite, a storage facility). In the stowed position, the slide out element is retracted into an interior space (e.g., a main living area, a bedroom, a storage area) within the recreational vehicle. In the deployed position, the slide out element is extended laterally outward from the interior space so that the slide out element extends outward from an exterior wall of the recreational vehicle. In this way, the slide out element enables the interior space of the recreational vehicle to be selectively expanded (e.g., when the slide out element is in the deployed position, thereby providing a larger living area) and enables the exterior footprint of the recreational vehicle to be selectively reduced (e.g., with the slide out element is in the stowed position for traveling).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an example of a fixed slide out cover described herein.

FIG. 2 is a diagram of an example of a fixed slide out cover described herein.

FIG. 3 is a diagram of an example of a fixed slide out cover described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

When a slide out element is in the deployed position, the exterior surfaces of the slide out element are exposed to environmental elements such as dust, dirt, rain, snow, sun, and/or leaves, among other examples. These environmental elements can cause wear to the exterior surfaces and/or to an upper gasket seal of the slide out element over time, which can reduce the life of the slide out element and/or cause the slide out element to fail. Moreover, environmental elements such as rain and leaves can be pulled into the interior space of a recreational vehicle, resulting in the interior space becoming dirty and/or damaged from the environmental elements.

As described herein, a fixed slide out cover may be secured to a recreational vehicle so that the fixed slide out cover spans a top area above a slide out element. For example, the fixed slide out cover may be secured to an exterior wall of the recreational vehicle and to the slide out element so that the fixed slide out cover protects the top surface of the slide out element from environmental elements such as dust, dirt, rain, snow, sun, and/or leaves, among other examples.

The fixed slide out cover is “fixed” in that the fixed slide out cover is formed to a fixed length based on the distance between the exterior wall of the recreational vehicle and a distal end of the slide out element. This enables the fixed slide out cover to be pulled tight over the top surface of the slide out element, and enables the fixed slide out cover to resist sagging or billowing that other types of slide out covers may be prone to, such as retractable slide out covers. Moreover, the fixed nature of the fixed slide out cover enables the fixed slide out cover to be fitted with side flaps that extend from the sides of the main body of the fixed slide out cover over at least a portion of the sidewall surfaces of the slide out element.

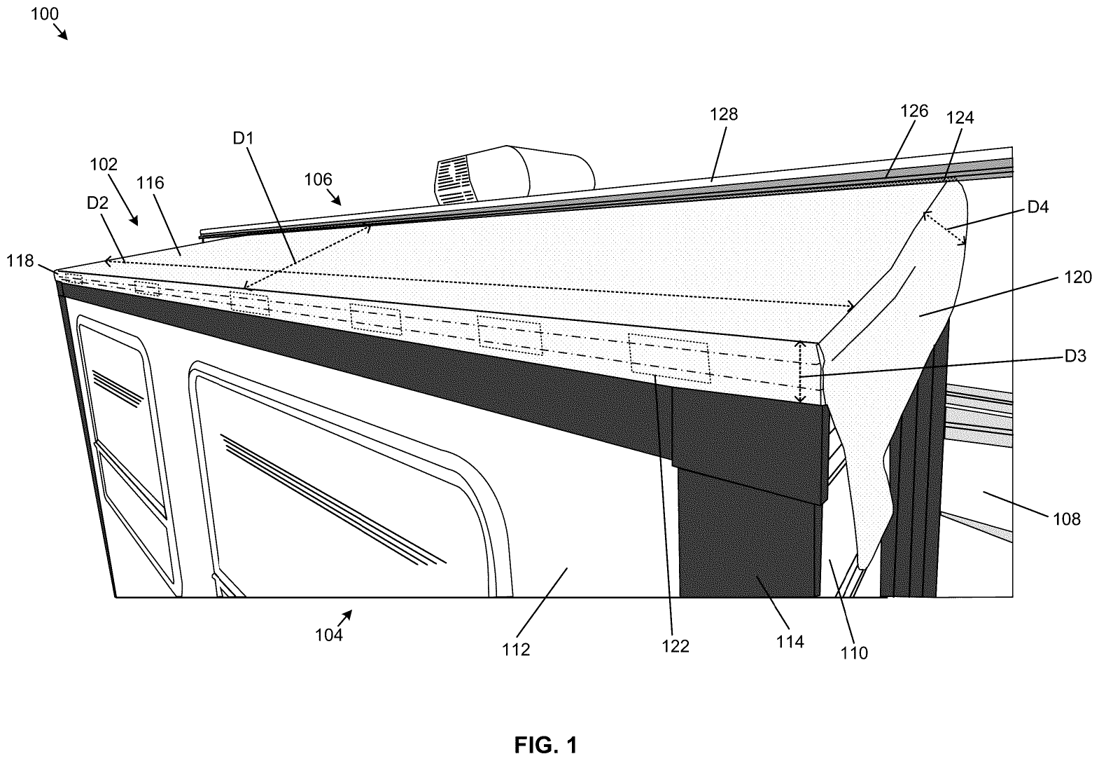

FIG. 1 is a diagram of an example 100 of a fixed slide out cover 102 described herein. The slide out cover 102 may be configured to be used with a slide out element 104 of a recreational vehicle 106. Examples of such recreational vehicles include, but are not limited to, motorhomes, towable recreational vehicles, and/or other types of recreational vehicles that include at least one slide out element 104. Examples of motorhomes include Class A motorhomes, Class B motorhomes, and/or Class C motorhomes, among other examples. Examples of towable recreational vehicles include travel trailers, fifth wheels, and/or toy haulers, among other examples. A recreational vehicle 106 may also be a slide-in camper (or “truck camper”) that includes at least one slide out element 104.

The slide out element 104 may be configured to laterally move in and out of an interior space within the recreational vehicle 106. The slide out element 104 may house various interior elements within the interior space of the recreational vehicle 106, such as dining furniture, couches, chairs, kitchens, bedroom storage, bathroom elements (e.g., showers, vanity sinks), bunks, beds, and/or refrigerators, among other examples.

The slide out 104 may be located in an exterior surface 108 (e.g., an exterior wall) of the recreational vehicle 106. The exterior surface 108 may be a sidewall of the recreational vehicle 106, a back wall of the recreational vehicle 106, and/or another wall of the recreational vehicle 106. In a stowed position, the slide out element 104 is laterally moved into the inner space of the recreational vehicle 106 such that sidewalls 110 of the slide out element 104 are retracted through the exterior surface 108 into the inner space of the recreational vehicle 106. In a deployed position (which is illustrated in the example 100 in FIG. 1), the slide out element 104 is laterally moved out of the inner space of the recreational vehicle 106 such that the sidewalls 110 of the slide out element 104 are extended through the exterior surface 108 out the inner space of the recreational vehicle 106.

As further shown in FIG. 1, the slide out element 104 includes an outer surface 112 (or outer wall) attached to the sidewalls 110. The outer surface 112, the sidewalls 110, and bottom and top surfaces (not shown in FIG. 1) define an inner space of the slide out element 104. A border 114 may be included around the perimeter of the outer surface 112. The border 114 may be included to protect the perimeter from damage, to cover up ends of a surface finish (e.g., fiberglass sheeting, metal siding) on the outer surface 112. In the stowed position, the border 114 may provide an environmental seal around the slide out element 104 against the exterior surface 108 of the recreational vehicle 106, and may include (or may be pressed against) a gasket to form the seal.

As further shown in FIG. 1, the fixed slide out cover 102 includes a main body 116 configured to be placed over the top surface of the slide out element 104 of the recreational vehicle 106 when the slide out element 104 is in a deployed position illustrated in FIG. 1. The main body 116 may include a fabric, such as a vinyl fabric, an acrylic fabric, and/or another type of durable fabric. The main body 116 has a length (dimension D1 in FIG. 1) and a width (dimension D2 in FIG. 1) that is configured such that the main body 116 covers the entire top surface of the slide out element 104.

The fixed slide out cover 102 is “fixed” in that the length of the main body 116 is a fixed length that approximately corresponds to a distance between the outer surface 112 of the slide out element 104 and the exterior surface 108 of the recreational vehicle 106 when the slide out element 104 is in the deployed position. In this way, the fixed length of the main body 116 enables the main body 116 to be pulled tight between the exterior surface 108 of the recreational vehicle 106 and the outer surface 112 of the slide out element 104 when the slide out element 104 is in the deployed position without excess material being rolled up on a roller as with retractable slide out covers. Instead, a first end of the main body 116 is secured to the exterior surface 108 of the recreational vehicle 106, a second end 118 of the main body 116 opposing the first end is secured over the border 114 of the outer surface 112 of the slide out element 104, and the main body 116 of the fixed slide out cover 102 is pulled tight between the first end and the second end 118.

The fixed length of the fixed slide out cover 102 enables the second end 118 to be pulled tightly over and fitted over the border 114 of the slide out element 104. The second end 118 may be configured to extend downward at least partially over the border 114 of the outer surface 112 of the slide out element 104. The second end 118 may be configured to be removably secured directly to the border 114 (e.g., as opposed to a roller as in the case of a retractable slide out cover) of the outer surface 112 of the slide out element 104.

The width of the main body 116 (dimension D2) may correspond to a length of the border 114 along the top of the outer surface 112 of the slide out element 104. This enables the fixed slide out cover 102 to include side flaps 120 extending from opposing sides of the main body 116. The side flaps 120 may be configured to extend along opposing sidewalls 110 of the slide out element 104 when the slide out element is in the deployed position. The side flaps 120 may extend between the first end and the second end 118 of the fixed slide out cover 102 and may at least partially cover a gap between the main body 116 of the fixed slide out cover 102 and the top surface of the slide out element 104 to protect against rain, leaves, and/or other environmental elements from landing on the top surface of the slide out element 104.

In some cases, the side flaps 120 are free floating and not secured to other sections of the fixed slide out cover 102 other than the main body 116. In some cases, sections of the side flaps 120 are secured to the second end 118 of the fixed slide out cover 102. For example, sections of the side flaps 120 are secured to the second end 118 of the fixed slide out cover 102 by hook and loop fasteners, by snap fasteners, by zippers, by sewing, and/or by another attachment device. In some cases, ends of the slide flaps 120 are secured to the border 114 of the outer surface 112 of the slide out element 104.

As shown in FIG. 1, the second end 118 may have a length (dimension D3 in FIG. 1) that enables the second 118 to drape over the border 114 of the slide out element 104, and the side flaps 120 may have a length (dimension D4 in FIG. 1) that enable the side flaps 120 to extend along the sidewalls 110 of the slide out element 104. In some cases, the length of the second end 18 and the length of the side flaps 120 are approximately equal. In some cases, the length of the second end 18 is greater than the length of the side flaps 120. In some cases, the length of the side flaps 120 is greater than the length of the second end 118.

As further shown in FIG. 1, the second end 118 may have one or more attachment devices 122 that are configured to attach the second end 118 of the fixed slide out cover 102 to the border 114 (e.g., directly to the border 114) of the outer surface 112 of the slide out element 104. The attachment device(s) 122 may include one or more hook and loop strips, a plurality of snap fasteners, a zipper, adhesive strips, latches, J-hooks, other types of fasteners, and/or a combination thereof. In some cases, the attachment device(s) 122 include an awning rod that slides into an awning rail on the border 114 of the slide out element 104. The awning rod may include a metal rod, a poly rod, and/or another type of stiff or semi-stiff rod that can be secured within the awning rail.

In some cases, the attachment device(s) 122 are configured to secure the second end 118 of the fixed slide out cover 102 to the border 114 of the outer surface 112 of the slide out element 104 without drilling into the border 114 or into the outer surface 112 of the slide out element 104 using screws. In this way, the use of the fixed slide out cover 102 does not damage the slide out element 104. Thus, if the recreational vehicle 106 is to be moved to a different location (e.g., which would necessitate the slide out element 104 being stowed in the stowed position), the fixed slide out cover 102 can be removed without needing to repair the slide out element 104 (e.g., patch holes in the slide out element 104). However, other attachment device(s) 122 such as screws may be used to cure the second end 118 of the fixed slide out cover 102 to the border 114 of the outer surface 112 of the slide out element 104.

As further shown in FIG. 1, the first end of the fixed slide out cover 102 has one or more attachment devices 124 that are configured to secure the main body 116 to the exterior surface 108 of the recreational vehicle 106. The attachment device(s) 124 may include one or more hook and loop strips, a plurality of snap fasteners, a zipper, adhesive strips, latches, J-hooks, other types of fasteners, and/or a combination thereof. In some cases, the attachment device(s) 124 include an awning rod that slides into an awning rail 126 on the exterior surface 108 of the recreational vehicle 106. The awning rod may include a metal rod, a poly rod, and/or another type of stiff or semi-stiff rod that can be secured within the awning rail. The awning rail 126 may be located at the top of the exterior surface 108 near a roof 128 of the recreational vehicle 106, and may seal the edges of the roofing material of the roof 128, as well as may include gutters for the roof 128. Alternatively, the awning rail 126 may be located further down on the exterior surface 108. For example the awning rail 126 may be integrated into a gutter for the slide out element 104.

In some cases, the attachment device(s) 122 and the attachment device(s) 124 include the same type of attachment device. In some cases, the attachment device(s) 122 and the attachment device(s) 124 include different types of attachment devices.

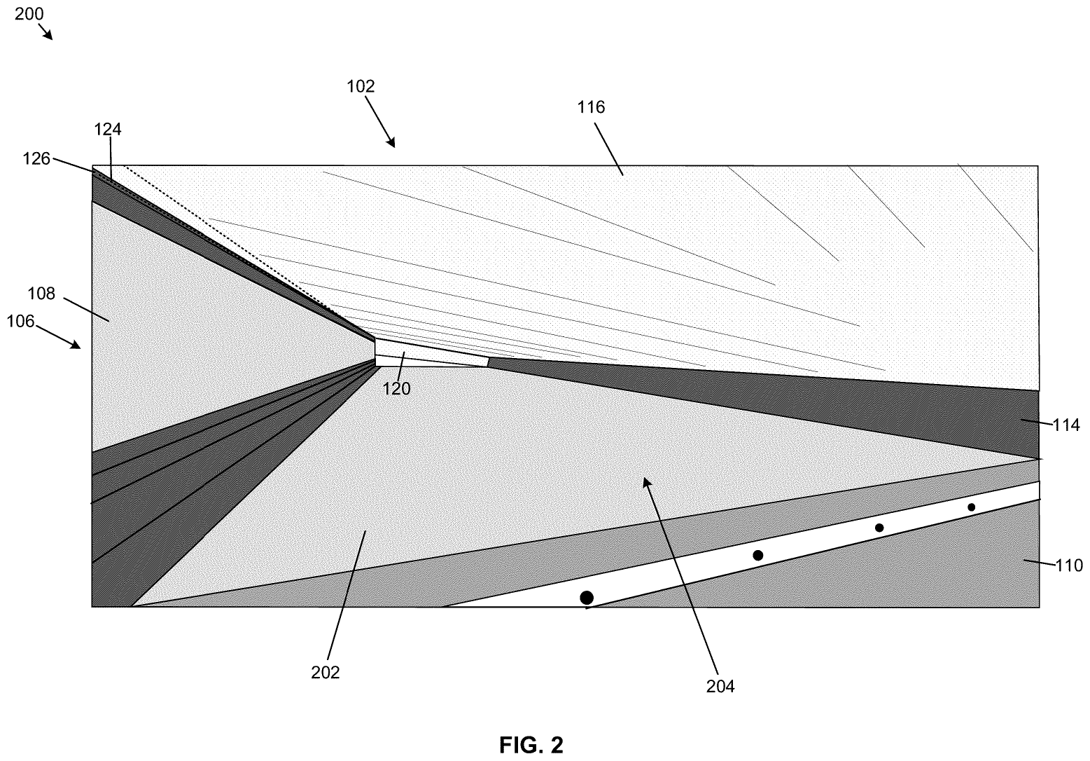

FIG. 2 is a diagram of an example 200 of a fixed slide out cover 102 described herein. As shown in FIG. 2, the main body 116 of the fixed slide out cover 102 is pulled tight over a top surface 202 of the slide out element 104 between the exterior surface 108 of the recreational vehicle 106 and the border 114 on the outer surface 112 of the slide out element 104. This creates a gap 204 between the top surface 202 and the main body 116. The attachment device 124 at the first end of the fixed slide out cover 102 may be secured to a location on the exterior surface 108 that is higher than the top of the border of the slide out element 104 so that the main body 116 is angled downward away from the exterior wall 108 of the recreational vehicle 106. This promotes runoff of rain, snow, and/or other environmental elements away from the recreational vehicle 106.

As further shown in FIG. 2, the side flaps 120 extend downward from the main body 116 and cover a portion of the gap 204 between the main body 116 and the top surface 202 of the slide out element 104 at the sides of the slide out element 104 (note that the side flap 120 in the foreground in FIG. 2 is omitted for clarity). The main body 116 and the side flaps 120 prevent, minimize, and/or reduce the likelihood of environmental elements such as dust, dirt, rain, snow, sun, and/or leaves, among other examples, from landing on the top surface 202 of the slide out element 104.

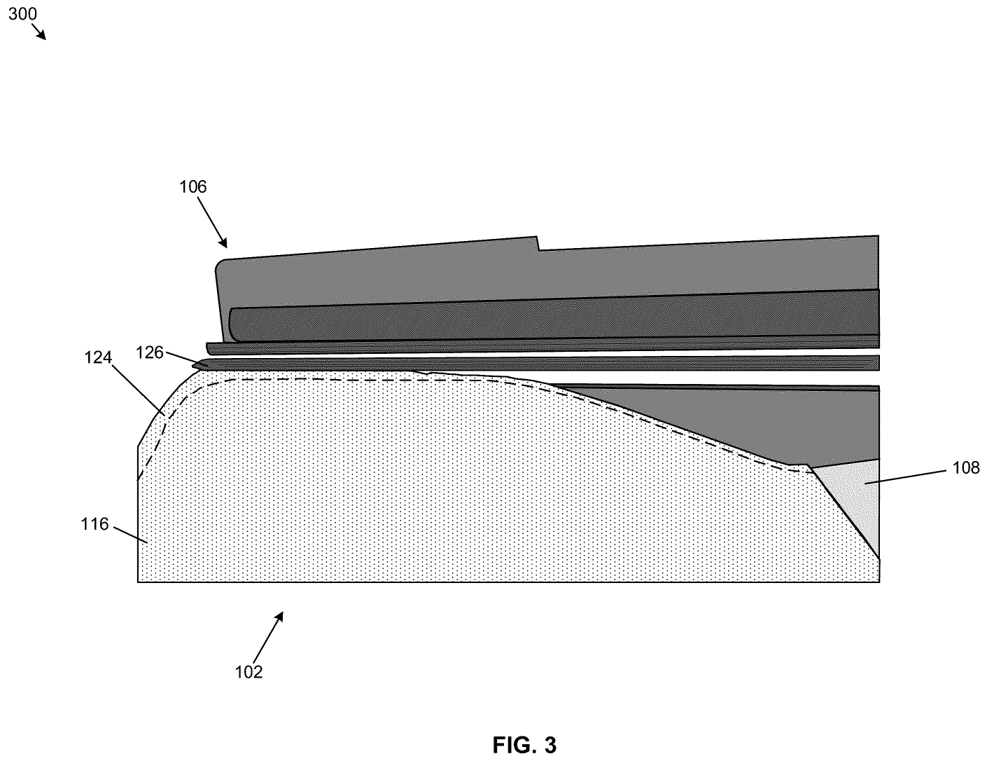

FIG. 3 is a diagram of an example 300 of a fixed slide out cover 102 described herein. FIG. 3, in particular, illustrates the details of the attachment device 124 at the first end of the fixed slide out cover 102. As shown in FIG. 3, the attachment device 124 may include an awning rod that slides into the awning rail 126 on the exterior surface 108 of the recreational vehicle 106. The awning rod may be secured to the main body 116 of the fixed slide out cover 102 by a hem, by an adhesive, and/or may be integrated into the main body 116, among other examples.

As used herein, spatial or directional terms, such as “left,” “right,” “front,” “back,” and the like, relate to the subject matter as it is shown in the drawing Figs. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification are understood as modified in all instances by the term “approximately. ” Each numerical parameter recited in the specification or claims which is modified by the term “approximately” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

What is claimed is:

1. A slide out cover, for use with a recreational vehicle, comprising:
a main body configured to be placed over a top surface of a slide out element of the recreational vehicle when the slide out element is in a deployed position;
a first end having an attachment device that is configured to be attached to an exterior surface of the recreational vehicle from which the slide out element is configured to laterally extend outward; and
a second end configured to be fitted over a border of an outer surface of the slide out element,
wherein a length of the main body approximately corresponds to a distance between the outer surface of the slide out element and the exterior surface of the recreational vehicle when the slide out element is in the deployed position.

2. The slide out cover of claim 1, wherein a width of the main body corresponds to a length of the border along the outer surface of the slide out element.

3. The slide out cover of claim 1, wherein the attachment device comprises one or more hook and loop strips.

4. The slide out cover of claim 1, wherein the attachment device comprises a plurality of snap fasteners.

5. The slide out cover of claim 1, wherein the attachment device comprises an awning rod that is configured to slide into an awning rail on the exterior surface of the recreational vehicle.

6. The slide out cover of claim 1, wherein the second end is configured to be removably secured directly to the border of the outer surface of the slide out element.

7. The slide out cover of claim 1, wherein the second end is configured to extend downward at least partially over the border of the outer surface of the slide out element.

8. A fixed slide out cover, for use with a recreational vehicle, comprising:
a main body configured to be placed over a top surface of a slide out element of the recreational vehicle;
a first end having an attachment device that is configured to be attached to an exterior surface of the recreational vehicle from which the slide out element is configured to laterally extend outward;
a second end configured to be fitted over a frame of an outer surface of the slide out element,
wherein a length of the main body approximately corresponds to a distance between the outer surface of the slide out element and the exterior surface of the recreational vehicle when the slide out element is in a deployed position; and
side flaps extending from opposing sides of the main body.

9. The fixed slide out cover of claim 8, wherein the side flaps are configured to extend along opposing sidewalls of the slide out element when the slide out element is in the deployed position.

10. The fixed slide out cover of claim 8, wherein sections of the side flaps are secured to the second end of the fixed slide out cover.

11. The fixed slide out cover of claim 8, wherein a length of the second end of the fixed slide out cover and a length of the side flaps of the fixed slide out cover are approximately equal.

12. The fixed slide out cover of claim 8, wherein and a length of the side flaps of the fixed slide out cover is greater than a length of the second end of the fixed slide out cover.

13. The fixed slide out cover of claim 8, wherein the side flaps extend between the first end and the second end of the fixed slide out cover.

14. The fixed slide out cover of claim 8, wherein ends of the slide flaps are secured to the border of the outer surface of the slide out element.

15. A fixed slide out cover, for use with a recreational vehicle, comprising:
a main body configured to be placed over a top surface of a slide out element of the recreational vehicle when the slide out element is in a deployed position;
a first end having a first attachment device that is configured to be attached to an exterior surface of the recreational vehicle from which the slide out element is configured to laterally extend outward; and
a second end configured to be fitted over a border of an outer surface of the slide out element,
wherein a length of the main body approximately corresponds to a distance between the outer surface of the slide out element and the exterior surface of the recreational vehicle when the slide out element is in the deployed position, and
wherein the second end has a second attachment device that is configured to be attached to the border of the outer surface of the slide out element.

16. The slide out fixed cover of claim 15, wherein the second attachment device comprises one or more hook and loop strips.

17. The slide out fixed cover of claim 15, wherein the second attachment device comprises a plurality of snap fasteners.

18. The slide out fixed cover of claim 15, wherein the first attachment device and the second attachment device are different types of attachment devices.

19. The slide out fixed cover of claim 15, wherein the second attachment device is configured to secure the second end of the fixed slide out cover to the border of the outer surface of the slide out element without drilling into the border or into the outer surface of the slide out element.

20. The slide out fixed cover of claim 15, wherein the second attachment device comprises an awning rod that is configured to slide into an awning rail on the border of the exterior surface of the slide out element.
